(19) United States
(12) Patent Application Publication
(10) Pub. No.: US 2016/0290302 A1
(43) Pub. Date: Oct. 6, 2016

(54) Fuel Injector Device and Method

(71) Applicant: Caterpillar Inc., Peoria, IL (US)

(72) Inventors: Scott F. Shafer, Morton, IL (US); David E. Hackett, Washington, IL (US); Craig Habeger, Chillicothe, IL (US)

(73) Assignee: Caterpillar Inc., Peoria, IL (US)

(21) Appl. No.: 14/679,225

(22) Filed: Apr. 6, 2015

(51) Int. Cl. F02M 61/18; B29C 67/00; G05B 19/4099; F02B 1/12

(52) U.S. Cl. CPC F02M 61/18; F02B 1/12; B29C 67/0088; G05B 19/4099; G05B 2219/35134; G05B 2219/49007; B33Y 50/02

(57) ABSTRACT

A fuel injector may include a nozzle assembly and a body. The body may have a fuel inlet, a nozzle supply passage fluidly coupled to the nozzle assembly, and an internal surface defining a chamber within the body. The fuel inlet may be fluidly coupled to the nozzle supply passage via the chamber. The fuel inlet defines an inlet dimension and the chamber defines a chamber dimension, the chamber dimension being larger than the inlet dimension.

### TECHNICAL FIELD

This disclosure relates generally to fuel injectors and, more particularly, to a fuel injector for a compression ignition engine and method for manufacturing a fuel injector for a compression ignition engine.

### BACKGROUND

Compression ignition engines are known for converting chemical energy in fuels, such as diesel fuel, into mechanical power. In a common rail direct injection compression ignition engine, multiple fuel injectors are fluidly coupled to a high-pressure pump via a common rail conduit. The fuel injection pressure from a high-pressure common rail fuel system may be on the order of 250 Megapascals (MPa). The fuel injectors deliver the pressurized fuel to respective cylinders of the engine in one or more injection shots per cycle.

The instantaneous fuel flow through one or more fuel injectors may differ from an instantaneous fuel flow through the fuel pump. To address this issue, a fluid volume of the common rail conduit may provide a fluid capacitance to store fluid energy when pump flow exceeds injector flow, and discharge fluid energy when injector flow exceeds pump flow. In some applications, the conventional common rail conduit may be a relatively large component and its placement across the engine in close proximity to the fuel injectors may interfere with the placement of other components.

International Publication No. WO2014186893 (hereinafter “the '893 publication”), titled “Fuel Injector,” purports to describe a fuel injector that includes a pressure accumulator. However, this pressure accumulator is located in the head portion of the fuel injector that extends out from the engine block. Because the head portion extends outside the engine block, enlarging the head portion of the fuel injector to accommodate the pressure accumulator may adversely impact the placement of other components around the engine.

Accordingly, there is a need for an improved fuel injector to address the problems described above and/or problems posed by other conventional approaches.

It will be appreciated that this background description has been created to aid the reader, and is not to be taken as an indication that any of the indicated problems were themselves known in the art.

### SUMMARY

An aspect of the present disclosure relates to a fuel injector. The fuel injector includes a nozzle assembly and a body. The body has a fuel inlet, a nozzle supply passage fluidly coupled to the nozzle assembly, and an internal surface defining a chamber within the body. The fuel inlet is fluidly coupled to the nozzle supply passage via the chamber. The fuel inlet defines an inlet dimension and the chamber defines a chamber dimension, the chamber dimension being larger than the inlet dimension.

Another aspect of the present disclosure pertains to a method of manufacturing a fuel injector. In this method, a 3 dimensional (3D) model of an injector body piece is generated. The injector body piece includes a fuel inlet defining an inlet dimension, a nozzle supply passage fluidly coupled to a nozzle assembly of the fuel injector, and an internal surface defining a chamber within the body. The chamber defining a chamber dimension. The fuel inlet is fluidly coupled to the nozzle supply passage via the chamber. The chamber dimension is larger than the inlet dimension. The 3D model is divided into a series of layers. A computer readable set of instructions is generated for fabricating each layer of the series of layers. The series of layers are fabricated based on the corresponding set of instructions. Each layer of the series of layers is consolidated with an overlapping portion of a previous layer.

Yet another aspect of the present disclosure relates to a fuel injector component. The fuel injector component includes a fuel inlet, a nozzle supply passage, and means for accumulating fuel pressure fluidly coupled between the fuel inlet and the nozzle supply passage.

It is to be understood that the disclosure is not limited in its application to the details of construction and to the arrangements of the components set forth in the following description or illustrated in the drawings. The disclosed device and method are capable of aspects in addition to those described and of being practiced and carried out in various ways. Also, it is to be understood that the terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the various aspects. It is important, therefore, that the claims be regarded as including such equivalent constructions insofar as they do not depart from the spirit and scope of the various aspects.

### BRIEF DESCRIPTION OF THE DRAWINGS

FIG. 1 is a cross sectional view of a fuel injector, according to an aspect of the disclosure.

FIG. 2 is a cross sectional view of a control valve assembly of the fuel injector, according to an aspect of the disclosure.

FIG. 3 is a cross sectional view of an injector body piece for the fuel injector, according to an aspect of the disclosure.

FIG. 4 is another cross sectional view of the injector body piece, according to an aspect of the disclosure.

FIG. 5 is a cross sectional view along section 5-5 of the injector body piece, according to an aspect of the disclosure.

FIG. 6 is an end view along section 6-6 of the injector body piece, according to an aspect of the disclosure.

FIG. 7 is a flow diagram of a method of fabricating the fuel injector body piece, according to an aspect of the disclosure.

The drawings presented are intended solely for the purpose of illustration and that they are, therefore, neither desired nor intended to limit the subject matter of the disclosure to any or all of the exact details of construction shown, except insofar as they may be deemed essential to the claims.

### DETAILED DESCRIPTION

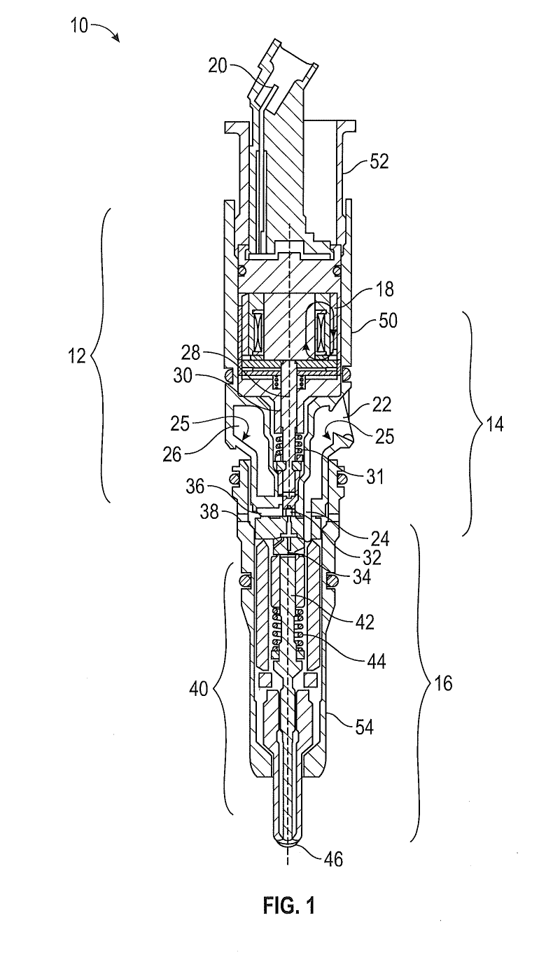

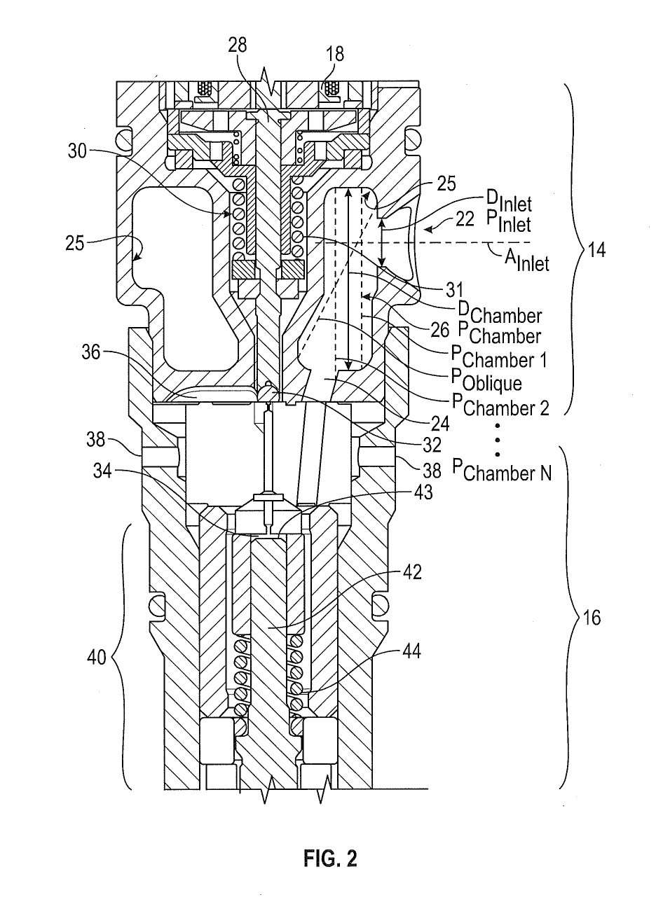

Referring to FIGS. 1 and 2, a fuel injector 10 may include a body 12, a control valve assembly 14, and a nozzle assembly 16. In FIGS. 1 and 2, the cross section plane passes through a center longitudinal axis of the fuel injector 10. In general, the fuel injector 10 is configured to control a flow of fuel from a fuel pump (not shown) into a combustion chamber of an engine (not shown). While the fuel injector 10 may be suitable for injecting any type of fuel into any type of engine, in a particular example, the fuel injector 10 is configured to inject diesel fuel into a diesel compression ignition engine.

The body 12 may include an actuator 18 and a contact 20. The body 12 may house the actuator 18 and, in response to power or signals received at the contact 20, the actuator 18 may be energized or otherwise caused to move. In various examples, the actuator 18 may include a solenoid actuator, piezoelectric actuator, hydraulic actuator, or any other fuel injector actuator known in the art. As described herein, the movement of the actuator 18 controls the operation of the fuel injector 10.

The control valve assembly 14 may include a fuel inlet 22, a nozzle supply passage 24, and an internal surface 25 defining a chamber 26. Although the exemplary embodiment is shown including a chamber 26 having a generally toroidal configuration, it should be apparent to one of ordinary skill that chamber 26 may be configured in other regular or irregular geometric arrangements based on particular space constraints and applications. The fuel inlet 22 is configured to receive fuel from a source, such as the fuel pump. In some examples, the fuel received may be at a relatively high pressure such as, about 100-300 Megapascals (MPa). The nozzle supply passage 24 is configured to convey the fuel to the nozzle assembly 16.

The chamber 26 is, in general, an enlarged portion disposed between and fluidly connecting the fuel inlet 22 and the nozzle supply passage 24. More particularly, a cross sectional area of the chamber 26 is comparatively larger than both a cross sectional area of the fuel inlet 22 and a cross sectional area of the nozzle supply passage 24. As seen best in FIG. 2, the cross sectional area of the chamber 26 may be greater than half a cross sectional area of the body 12.

Yet more particularly and as shown in FIG. 2, the fuel inlet 22 defines an inlet dimension (Dᵢₙₗₑₜ) and the chamber 26 defines a chamber dimension (D_{chamber}) and the chamber dimension D_{chamber} is larger than the inlet dimension Dᵢₙₗₑₜ. Also shown in FIG. 2, the fuel inlet 22 defines an inlet plane (Pᵢₙₗₑₜ) and an inlet axis (Aᵢₙₗₑₜ) oriented perpendicular to the inlet plane Pᵢₙₗₑₜ. The chamber 26 defines a chamber plane (P_{chamber}) separated from the inlet plane Pᵢₙₗₑₜ along the inlet axis Aᵢₙₗₑₜ. The inlet plane Pᵢₙₗₑₜ has a dimension equal to the inlet dimension Dᵢₙₗₑₜ and the chamber plane P_{chamber} has a dimension equal to the chamber dimension D_{chamber}. The chamber 26 further defines a plurality of chamber planes (P_{chamber1}, P_{chamber2}, . . . P_{chamberN}) spaced apart from the inlet plane Pᵢₙₗₑₜ along the inlet axis Aᵢₙₗₑₜ, each of the plurality of the chamber planes P_{chamber1}, P_{chamber2}, . . . P_{chamberN} has a dimension normal to inlet axis Aᵢₙₗₑₜ and larger than the inlet dimension Dᵢₙₗₑₜ. In this or other examples, a chamber plane may be oriented at an angle oblique (P_{oblique}) to the inlet axis Aᵢₙₗₑₜ.

The control valve assembly 14 may further include a pin 28 that is moved by the action of the actuator 18. The pin 28 may be disposed along a center portion of the control valve assembly 14 proximate to the chamber 26 in a pin passageway 30. In the exemplary embodiment, the chamber 26 is shown having a toroidal configuration disposed about the pin 28 within pin passageway 30. The pin 28 may include a biasing spring 31 configured to bias the pin 28 toward a control valve member 32 which, in turn, is configured to regulate fluid pressure and flow to a needle control chamber 34. That is, the actuator 18 is operatively coupled to the needle control chamber 34 via the pin 28. The pin 28 is urged away from the control valve member 32 in response to energizing the actuator 18. Releasing the control valve member 32 fluidly connects the needle control chamber 34 to a drain passage 36 and allows pressurized fuel to flow from the needle control chamber 34 and then drain from the fuel injector 10 via a drain outlet 38. In operation, fuel may flow from the drain outlet 38 back to a fuel tank (not shown). De-energizing the actuator 18 allows the biasing spring 31 to urge the pin 28 toward the control valve member 32 to seal the needle control chamber 34.

The nozzle assembly 16 may include a needle valve 40 that receives fuel from the nozzle supply passage 24. The needle valve 40 may include a needle 42 having a needle control surface 43, a biasing spring 44, and a nozzle outlet 46. In response to fuel being drained from the needle control chamber 34, the fuel pressure in the needle control chamber 34 and the net pressure on the needle control surface 43 causes the needle 42 to open the nozzle outlet 46 and allow fuel to flow therethrough. In response to the control valve member 32 sealing the needle control chamber 34, incoming fuel is allowed to re-pressurize the needle control chamber 34 and the net fluid pressure force acting on the needle control surface 43 is less than the spring bias force of the biasing spring 44, so the biasing spring 44 urges the needle 42 forward to close the needle valve 40. While only a single nozzle outlet 46 is described, the nozzle outlet 46 may include one or more outlet orifices.

The chamber 26 may be formed in the control valve assembly 14 in any suitable manner. Examples of suitable forming methods may include casting, machining of solid stock, additive manufacturing, and the like. In a particular example of additive manufacturing, the control valve assembly 14 may be foamed via three dimensional (3D) metal printing. As is generally known, 3D metal printing includes various additive fabrication processes in which successive layers of material are deposited, one upon another, to build up a component. Additive manufacturing processes that may be utilized and that are contemplated within the present disclosure include, but are not limited to: stereolithography; photopolymerization stereolithography; mask image stereolithography; metal-sintering; selective laser sintering; direct metal laser sintering; selective laser melting; laser engineered net shaping; wire arc processes; electron beam melting; fused deposition modeling; inkjet deposition; polyjet printing; inkjet material deposition; drop-on-drop material deposition; laminated object manufacturing; subtractive manufacturing processes; combined additive and subtractive manufacturing processes; Arburg Kunststoff free forming; combinations thereof; and any other additive manufacturing processes know in the art.

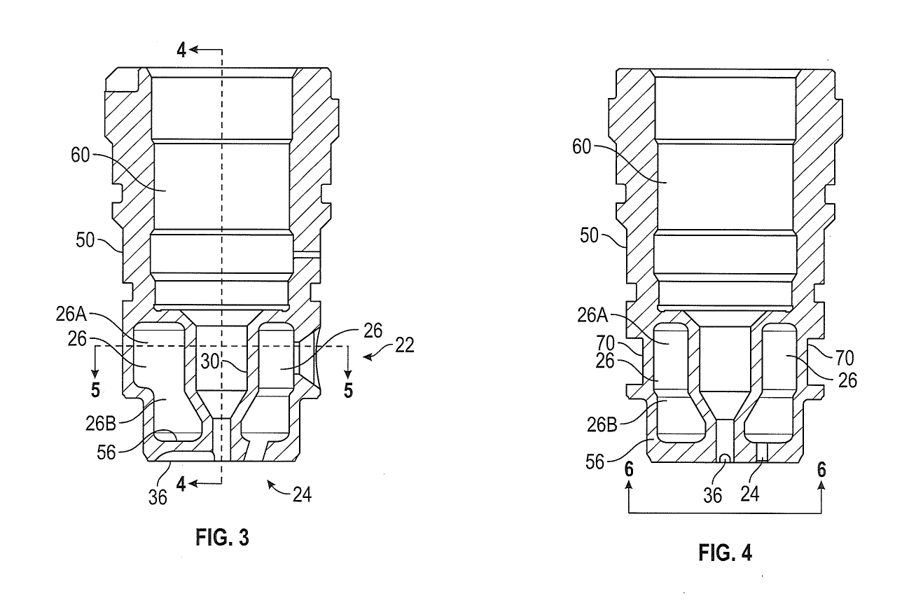

In the particular example shown in FIG. 1, the chamber 26 is disposed within an injector body piece 50, and the injector body piece 50 may generally be housed in or be a sub-assembly of the body 12. Examples of the injector body piece 50 are shown more clearly in FIGS. 3 and 4. As shown in FIGS. 3 and 4, 3D metal printing may be particularly suitable for fabricating the injector body piece 50 due to the injector body piece 50 being unitary in construction and the enclosed or hollow cavity nature of the chamber 26. Also shown in FIGS. 3 and 4, a radiused corner 56 may be formed in the corners of the chamber 26 to strengthen the corners against the pressure of the fuel during operation. Following fabrication, the chamber 26 may be strengthened via autofrettage. In a particular example, the chamber 26 is pre-stressed or subject to sufficient pressure to strain the walls defining the chamber 26 past their elastic limit. This relatively high stress technique is utilized to generate residual stress or induce compressive stresses that increase the resistance to stress corrosion cracking and the like. An example of the autofrettage technique can be found in US Patent Publication No. 20140331729, the content of which is incorporated herein by reference.

In the particular example of the chamber 26 shown in FIGS. 3 and 4, the chamber 26 is a stepped toroidal chamber. That is, the chamber 26 may include a stepped set of toroids, with one toroid 26A being disposed upon another toroid 26B in order to maximize the internal volume of the chamber 26 while accommodating the pin passageway 30. In some examples, the chamber 26 may include flattened portions to accommodate an optional pair of bearing surfaces 60. The pair of bearing surfaces are disposed diametrically across from and parallel to one another. If included, these bearing surfaces 60 may facilitate assembly and/or servicing by providing mating surfaces for a tool. Also shown in FIGS. 3 and 4, the chamber 26 may include a plurality of nozzle supply passages 24 configured to supply fuel to the needle valve 40. This plurality of nozzle supply passages 24 may improve some flow characteristics of fuel flowing from the chamber 26 into the needle valve 40 in comparison to a single nozzle supply passage 24.

Returning to FIG. 1, once the injector body piece 50 is fabricated, the pin 28 and actuator 18 are installed in the top end and secured with a head cap 52 that may include the contact 20. The nozzle assembly 16 is assembled by placing the needle valve 40 into a tail sleeve 54 and the nozzle assembly 16 is secured to a bottom portion of the injector body piece 50. In this manner, the fuel injector 10 is assembled.

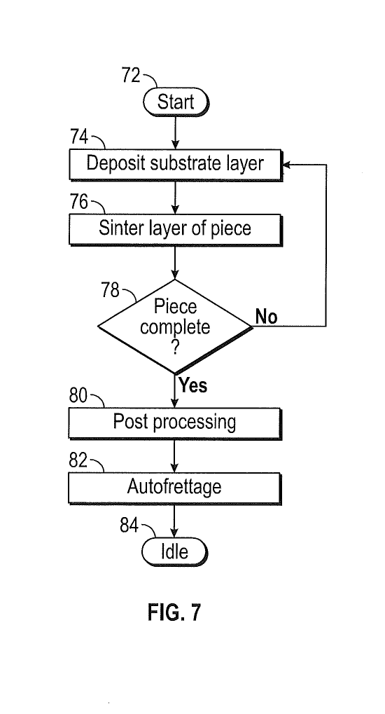

FIG. 7 is a flow diagram of a method 70 of fabricating the injector body piece 50, according to an aspect of the disclosure. In the following description of the method 70, particular example is made of manufacturing the injector body piece 50 via selective laser sintering. Selective laser sintering is an additive manufacturing technique that uses a laser as the heat source to sinter powdered metal, aiming the laser via computer numerical control (CNC) at points in space defined by a 3D model, binding the powdered metal together to create a solid structure that corresponds to the 3D model. Sintering is generally a process of forming a solid mass of fused particles via the application of heat and without melting to the point of liquefaction. However, in other examples, any suitable manufacturing process may be utilized to fabricate the injector body piece 50 from any suitable material. Examples of suitable materials include steel, titanium, aluminum, various alloys thereof, and/or the like.

Prior to the method 70, the 3D model corresponding to the injector body piece 50 may be modelled and a computer-readable file coding a set of instructions corresponding to the 3D model may be forwarded to one or more additive manufacturing machines. Depending upon a size of a work area of the additive manufacturing machine, one or more of the injector body pieces 50 may be fabricated simultaneously. For example, if the injector body piece 50 has a diameter of less than 5 centimeters, an array of 20 by 20 (i.e., 400) of the injector body pieces 50 may be simultaneously fabricated on a one meter square work area.

As shown in FIG. 7, the method 70 may be initiated at step 72. For example, the additive manufacturing machine may be powered on, the computer-readable file coding a set of instructions corresponding to the 3D model may be forwarded to a controller configured to control the additive manufacturing machine, and the like.

At step 74, a substrate layer may be deposited in the work area. For example, a layer of the powdered metal may be deposited over at least a portion of the work area. The powdered metal may be deposited in a substantially even layer. The thickness of the layer may depend on a variety of factors. These factors may include a size of features being fabricated on the injector body piece 50, power of the laser, manufacturer's specifications, empirical data, and/or the like. In a particular example, the thickness of the layer may be between 0.001 mm to 0.1 mm.

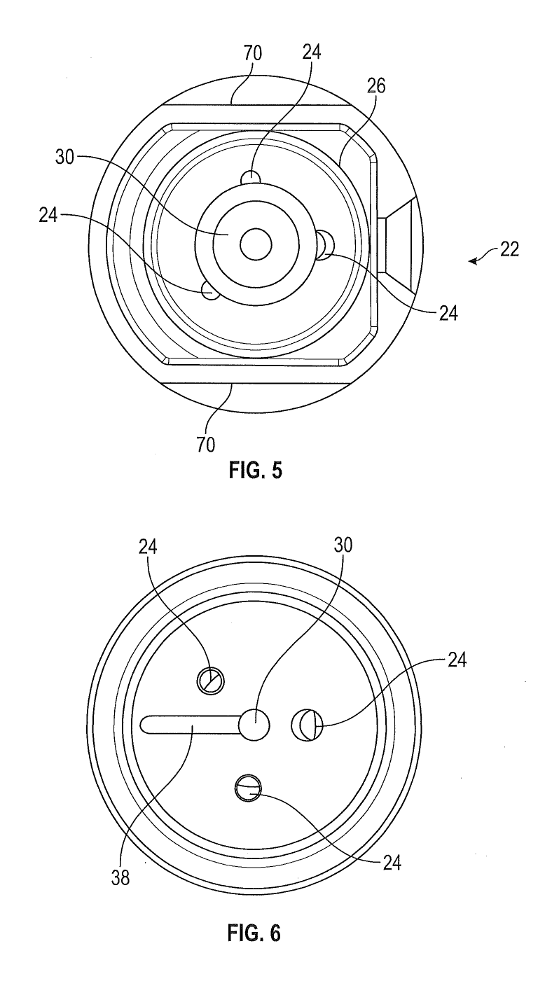

At step 76, the deposited layer may be sintered. For example, the laser is controlled in response to the computer-readable file coding the set of instructions corresponding to the 3D model to sinter the layer of powdered metal in a pattern corresponding to a particular slice or layer of the 3D model. As steps 74 and 76 are repeated, the injector body piece 50 is built up, layer by layer. As each subsequent layer is sintered, the portion of the new layer overlapping the previously layer is consolidated or fused together to form the various features of the injector body piece 50. In particular, the chamber 26 and various passages may be formed in this method. As shown in FIGS. 1-6, the geometry of the chamber 26 is such that it would be economically infeasible or impossible with conventional machining techniques. However, using additive manufacturing, the volume of the chamber 26 in the injector body piece 50 may be enlarged or expanded to occupy substantially all unutilized space in the injector body piece 50.

At step 78, it is determined if the injector body piece 50 is complete. For example, is an end of file statement in the computer-readable file coding the set of instructions corresponding to the 3D model is reached, it may be determined that the injector body piece 50 is complete. In another example, if the computer-readable file includes additional instructions for layers of the 3D model corresponding to the injector body piece 50, it may be determined that the injector body piece 50 is not complete and an additional layer of powdered metal may be deposited at step 74.

At step 80, the injector body piece 50 may be post processed in response to it being determined that the injector body piece 50 was completed at step 78. Examples of post processing include removing the injector body piece 50 from the work area, removing unconsolidated powdered metal, polishing, coating, machining, and the like.

At step 82, the injector body piece 50 is, optionally, autofrettaged to induce compressive residual stress in the internal surface 25 of the chamber 26. If performed, the autofrettage process may include sealing the nozzle supply passage 24 and introducing an autofrettage liquid at sufficient pressure via the fuel inlet to cause the internal surface 25 to plastically yield. In response to releasing the pressure of the autofrettage liquid, a compressive residual stress is induced in the internal surface 25.

### INDUSTRIAL APPLICABILITY

The present disclosure may be applicable to any fuel injector. Aspects of the disclosed fuel injector and method may promote operational flexibility, performance, and reduced size of fuel injection systems.

The instantaneous fuel flow through one or more fuel injectors may differ from an instantaneous fuel flow through the fuel pump. To address this issue, a fluid volume of the common rail conduit may provide a fluid capacitance to store fluid energy when pump flow exceeds injector flow, and discharge fluid energy when injector flow exceeds pump flow. Fluid energy may be stored in the fluid volume of the common rail conduit via an elastic expansion of the common rail conduit, for example. In addition, given the time scale of injection events and the pressures that are typically present in common rail systems, fuel may exhibit compressible flow characteristics. Accordingly, the fuel itself can provide a measure of resilience for storing fluid energy in an accumulator.

Applicants discovered that in a conventional common rail injection system, there is a short delay between the time the fuel injector valve opens and the time fuel flows out the injector at full force. This delay is due in part to the time it takes the mass of fuel being accelerated along the fuel line between the common rail and the fuel injector. In addition, the acoustic wave speed through the fuel dictates the amount of time it takes for a pressure difference in one portion of the fuel to reach another portion of the fuel. The path length of the fuel lines from the common rail to the fuel injector may also result in pressure decay depending on the duration of the injection event or the timing of two or more injection events. Applicants further discovered that the mass of fuel accelerated during an injection event in a conventional common rail injection system may cause a fluid hammer phenomenon, other fuel flow issues, and/or wear to the needle valve in the fuel injector. In some applications, the path length of the fuel lines from the common rail to the fuel injector may not be made shorter without impacting placement of other components of the engine.

Applicants discovered a number of beneficial effects by relocating the pressure accumulation properties of the common rail into the fuel injector. For example, as shown in FIG. 1, having the chamber 26 disposed directly above the needle valve 40, the accelerated mass of fuel may be reduced in comparison to a common rail system. In comparison to a common rail system, this reduced mass of fuel can improve responsiveness of the injection event, reduces pressure decay, and reduces damage to the needle valve 40.

The chamber 26 is generally configured to facilitate an accumulation of pressurized fuel, or provide a fluid capacitance, in the body 12 of the fuel injector 10. That is, the chamber 26 functions as a pressure accumulator or hydraulic capacitor. In this regard, the chamber 26 may contribute additional fluid capacitance to that of a common rail conduit in a common rail fuel injection system, in that the chamber 26 promotes the supply of fuel at a suitable pressure and volume to supply the instantaneous demands of the fuel injector 10 and prevent or minimize a pressure decay that may occur during an injection event. To this end, the greater the volume of the chamber 26, the greater the fluid capacitance of the chamber 26. Generally, this increased volume is accomplished by increasing the diameter of the internal surface 25 relative to the diameter of the fuel inlet 22 and/or the nozzle supply passage 24. Additively manufacturing the chamber 26 within the body 12 facilitates an increased volume of the chamber 26 due to the ability of this manufacturing process to form the internal surface 25 that follows the contours of the various other features in the body 12 such as the pin passageway 30. These same contours or topography of the internal surface 25 may not be possible with conventional machining techniques.

The chamber 26 may be configured to function as a pressure accumulator or a hydraulic capacitor. The proximity of the chamber 26 to the nozzle outlet 46 can improve the responsiveness of the fuel injector 10 over conventional common rail with more distal pressure accumulators. That is, in a conventional common rail fuel injection system, a column of fuel in the fuel line from the common rail to the injector must be accelerated in order for an injection event to occur. In contrast, because the chamber 26 is located proximate to the needle valve 40, the mass of fuel being accelerated during an injection event is reduced. As such, there is a corresponding decrease in the time to accelerate this reduced mass of fuel at a given pressure of fuel. In addition, once the comparatively larger mass of fuel is accelerated in a conventional common rail system, the inertia of this larger mass of fuel resists stoppage of fluid flow and therefore may cause relatively more wear to the needle valve 40 than the comparatively smaller mass of fuel from the chamber 26.

The chamber 26 may further provide a heat sink to better cool the actuator 18 and other electromechanical components in the body 12. That is, the fuel disposed in the chamber 26 may absorb heat from the nozzle assembly 16 and convey that heat out of the fuel injector 10 via fuel flow into the engine cylinder during subsequent injection events. Because the chamber 26 fills the control valve assembly 14 with the exception of the pin passageway 30, the chamber 26 may act as a heat barrier.

Furthermore, the overall size of the fuel injection system may be reduced due to the pressure accumulating properties of the chamber 26. For example, because of pressure accumulating properties of the chamber 26, the volume of the common rail may be reduced and the fuel injection system may be made relatively more compact. Reducing the volume of the common rail may have an add-on effect of allowing the various fuel lines and pressure vessels to be made smaller and therefore lighter, easier to form, and less obtrusive to the placement of other components of the engine, or combinations thereof.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. Further, since numerous modifications and variations will readily occur to those skilled in the art, it is not desired to limit the aspects to the exact construction and operation illustrated and described, and accordingly, all suitable modifications and equivalents may be resorted to, falling within the scope of the various aspects.

We claim:

1. A fuel injector comprising:
a nozzle assembly; and
a body having:
a fuel inlet;
a nozzle supply passage fluidly coupled to the nozzle assembly; and
an internal surface defining a chamber within the body, the fuel inlet being fluidly coupled to the nozzle supply passage via the chamber, wherein the fuel inlet defines an inlet dimension and the chamber defines a chamber dimension, the chamber dimension being larger than the inlet dimension.

2. The fuel injector of claim 1 wherein the fuel inlet defines an inlet plane and an inlet axis oriented perpendicular to the inlet plane, and wherein the chamber defines a chamber plane separated from the inlet plane along the inlet axis, wherein the inlet plane has a dimension equal to the inlet dimension and the chamber plane has a dimension equal to the chamber dimension.

3. The fuel injector of claim 2 wherein the chamber further defines a plurality of chamber planes spaced apart from the inlet plane along the inlet axis, each of the plurality of the chamber planes having a dimension normal to inlet axis and larger than the inlet dimension.

4. The fuel injector of claim 2 wherein the chamber plane is oriented at an angle oblique to the inlet axis.

5. The fuel injector according to claim 1, wherein the chamber is a toroidal chamber.

6. The fuel injector according to claim 5, wherein the toroidal chamber is a stepped toroidal chamber.

7. The fuel injector according to claim 1, further comprising an actuator operatively coupled to the nozzle assembly by a pin, wherein the chamber is disposed about the pin within the body.

8. The fuel injector according to claim 1, wherein the chamber includes a chamber cross sectional area, the fuel inlet includes an inlet cross sectional area, the nozzle supply passage includes a supply cross sectional area, and the chamber cross sectional area is comparatively larger than both the inlet cross sectional area and the supply cross sectional area.

9. The fuel injector according to claim 8, wherein the body includes a body cross sectional area and the chamber cross sectional area is greater than half the body cross sectional area.

10. A method for manufacturing a fuel injector, the method comprising the steps of:
generating a 3 dimensional (3D) model of an injector body piece, the injector body piece including:
a fuel inlet defining an inlet dimension;
a nozzle supply passage fluidly coupled to a nozzle assembly of the fuel injector; and
an internal surface defining a chamber within the injector body piece, the chamber defining a chamber dimension, and the fuel inlet being fluidly coupled to the nozzle supply passage via the chamber, wherein the chamber dimension is larger than the inlet dimension;
dividing the 3D model into a series of layers;
generating a computer readable set of instructions for fabricating each layer of the series of layers; and
fabricating the series of layers based on the computer readable set of instructions, wherein each layer of the series of layers is consolidated with an overlapping portion of a previous layer.

11. The method according to claim 10, further comprising the step of:
forming the chamber into a toroidal chamber.

12. The method according to claim 11, further comprising the step of:
forming the toroidal chamber into a stepped toroidal chamber.

13. The method according to claim 10, wherein the step of fabricating further comprises the steps of:
depositing a substrate layer; and
sintering the substrate layer in a pattern corresponding to the computer readable set of instructions.

14. The method according to claim 10, further comprising the step of:
forming the chamber to follow a contour corresponding to a pin passageway.

15. The method according to claim 10, wherein the chamber includes a chamber cross sectional area, the fuel inlet includes an inlet cross sectional area, the nozzle supply passage includes a supply cross sectional area, and wherein the step of fabricating further comprises the steps of:
forming the chamber cross sectional area comparatively larger than both the inlet cross sectional area and the supply cross sectional area.

16. The method according to claim 15, wherein the injector body piece includes a body cross sectional area and wherein the step of fabricating further comprises the steps of:
forming the chamber cross sectional area greater than half the body cross sectional area.

17. The method according to claim 10, further comprising the steps of:
sealing the nozzle supply passage; and
introducing an autofrettage liquid at sufficient pressure via the fuel inlet to cause the internal surface to plastically yield.

18. A fuel injector component comprising:
a fuel inlet;
a nozzle supply passage; and
means for accumulating fuel pressure fluidly coupled between the fuel inlet and the nozzle supply passage.

19. The fuel injector component according to claim 18, wherein the means for accumulating fuel pressure includes a first cross sectional area, the fuel inlet includes an inlet cross sectional area, the nozzle supply passage includes a supply cross sectional area, and the first cross sectional area is comparatively larger than both the inlet cross sectional area and the supply cross sectional area.

20. The fuel injector component according to claim 19, wherein the fuel injector component includes a fuel injector component cross sectional area and the first cross sectional area is greater than half the fuel injector component cross sectional area.
